(19) United States
(12) Patent Application Publication
(10) Pub. No.: US 2023/0095649 A1
(43) Pub. Date: Mar. 30, 2023

(54) BEAM DETERMINATION METHOD AND APPARATUS, AND COMMUNICATION DEVICE

(71) Applicant: Beijing Xiaomi Mobile Software Co., Ltd., Beijing (CN)

(72) Inventor: Wei HONG, Beijing (CN)

(73) Assignee: Beijing Xiaomi Mobile Software Co., Ltd., Beijing (CN)

(21) Appl. No.: 17/799,842

(22) PCT Filed: Feb. 17, 2020
(86) PCT No.: PCT/CN2020/075584

§ 371 Date: Aug. 15, 2022

(51) Int. Cl. H04W 16/28

(52) U.S. Cl. CPC H04W 16/28

(57) ABSTRACT

The embodiments of the present disclosure relate to a beam determination method and apparatus, and a communication device. The method includes: determining a first beam used for performing downlink communication with a terminal; determining sweeping beams of a base station according to a beam offset parameter, where the sweeping beams include: the first beam, and a second beam of which the offset between same and the first beam is within a beam offset range indicated by the beam offset parameter, receiving, on the sweeping beams, a reference signal sent by the terminal; selecting an uplink beam from the sweeping beams according to the received quality of the reference signal; and sending, to the terminal, beam information that indicates the uplink beam.

### CROSS REFERENCES TO RELATED APPLICATION

The present application is a U.S. National Stage of International Application No. PCT/CN2020/075584, filed on PCT Feb. 17, 2020, the contents of all of which are incorporated herein by reference in their entireties for all purposes.

### BACKGROUND

It is a key feature of 5G (5^{th} Generation) new radio (NR) to support a large number of directional controllable antenna elements at a transmitting end and a reception end. At a high frequency band, a large number of antenna elements can be used for beam forming, so as to reduce the width of a single beam to expand a coverage distance of the single beam. Further, the 5G system design introduces the concept of multiple beams to increase a coverage angle, such as covering the whole community.

### SUMMARY

According to a first aspect of examples of the disclosure, provided is a beam determination method. The method is performed by a base station and includes: determining a first beam used for performing downlink communication with a terminal; determining sweeping beams of a base station according to a beam offset parameter, where the sweeping beams include: the first beam and a second beam having an offset, relative to the first beam, falling within a beam offset range indicated by the beam offset parameter; receiving, on the sweeping beams, a reference signal sent by the terminal; selecting an uplink beam from the sweeping beams according to reception quality of the reference signal; and sending, to the terminal, beam information indicating the uplink beam.

According to a second aspect of examples of the disclosure, provided is a beam determination method. The method is performed by a terminal and includes: determining a first beam used for performing downlink communication between a base station and the terminal; determining sweeping beams of the base station according to a beam offset parameter, where the sweeping beams include: the first beam and a second beam having an offset, relative to the first beam, falling within a beam offset range indicated by the beam offset parameter; sending a reference signal to the base station on the sweeping beams; and receiving second beam information, indicating an uplink beam, sent by the base station, where the uplink beam is selected from the sweeping beams by the base station according to reception quality of a reference signal of each sweeping beam.

According to a third aspect of examples of the disclosure, provided is a beam determination apparatus. The apparatus is used for a base station and includes: a first determination module, a second determination module, a first reception module, a first selection module, and a first sending module, where the first determination module is configured to determine a first beam used for performing downlink communication with a terminal; the second determination module is configured to determine sweeping beams of a base station according to a beam offset parameter, where the sweeping beams include: the first beam and a second beam having an offset, relative to the first beam, falling within a beam offset range indicated by the beam offset parameter; the first reception module is configured to receive, on the sweeping beams, a reference signal sent by the terminal; the first selection module is configured to select an uplink beam from the sweeping beams according to reception quality of the reference signal; and the first sending module is configured to send, to the terminal, beam information indicating the uplink beam.

According to a fourth aspect of examples of the disclosure, provided is a beam determination apparatus. The apparatus is used for a terminal and includes: a third determination module, a fourth determination module, a second sending module, and a third reception module, where the third determination module is configured to determine a first beam used for performing downlink communication between a base station and the terminal; the fourth determination module is configured to determine sweeping beams of a base station according to a beam offset parameter, where the sweeping beams include: the first beam and a second beam having an offset, relative to the first beam, falling within a beam offset range indicated by the beam offset parameter; the second sending module is configured to send a reference signal to the base station on the sweeping beams; and the third reception module is configured to receive second beam information, indicating an uplink beam, sent by the base station, where the uplink beam is selected from the sweeping beams by the base station according to reception quality of a reference signal of each sweeping beam.

According to a fifth aspect of examples of the disclosure, provided is a communication device. The communication device includes a processor, a transceiver, a memory, and an executable program stored on the memory and executable by the processor, where the processor is configured to: determine a first beam used for performing downlink communication with a terminal; determine sweeping beams of a base station according to a beam offset parameter, where the sweeping beams include: the first beam and a second beam having an offset, relative to the first beam, falling within a beam offset range indicated by the beam offset parameter; receive, on the sweeping beams, a reference signal sent by the terminal; select an uplink beam from the sweeping beams according to reception quality of the reference signal; and send, to the terminal, beam information indicating the uplink beam.

According to a sixth aspect of examples of the disclosure, provided is a communication device. The communication device includes a processor, a transceiver, a memory, and an executable program stored on the memory and executable by the processor, where the processor is configured to execute, when running the executable program, steps of the beam determination method according to the second aspect.

It is to be understood that both the foregoing general description and the following detailed description are illustrative and explanatory and are not restrictive of examples of the disclosure.

### BRIEF DESCRIPTION OF THE DRAWINGS

The accompanying drawings, which are incorporated in and constitute a part of this specification, illustrate examples consistent with the disclosure and, together with the specification, serve to explain the principles of the examples of the disclosure.

FIG. 1 is a structural schematic diagram of a communication system according to an example;

FIG. 2 is a schematic diagram illustrating uplink beam determination according to an example;

FIG. 3 is a flow diagram of a beam determination method according to an example;

FIG. 4 is a schematic diagram illustrating uplink beam determination according to an example;

FIG. 5 is a schematic diagram illustrating another uplink beam determination according to an example;

FIG. 6 is a flow diagram of another beam determination method according to an example;

FIG. 7 is a flow diagram of yet another beam determination method according to an example;

FIG. 8 is a structural block diagram of composition of a beam determination apparatus according to an example;

FIG. 9 is a structural block diagram of composition of another beam determination apparatus according to an example; and

FIG. 10 is a block diagram of a beam determination apparatus according to an example.

### DETAILED DESCRIPTION

Description will herein be made in detail to illustrative examples, instances of which are illustrated in the accompanying drawings. When the following description refers to the accompanying drawings, the same numbers in different accompanying drawings refer to the same or similar elements unless otherwise indicated. The implementation modes described in the following illustrative examples do not represent all implementation modes consistent with the examples of the disclosure. Rather, they are merely instances of apparatus and methods consistent with some aspects of the examples of the disclosure as described in detail in the appended claims.

The terms used in the examples of the disclosure are for the purpose of describing particular examples merely and are not intended to be restrictive of the examples of the disclosure. As used in the examples and the appended claims of the disclosure, singular forms “a”, “an” and “the” are intended to include plural forms as well, unless the context clearly indicates otherwise. It is to be understood that the term “and/or” as used herein refers to and encompasses any or all possible combinations of one or more of the associated listed items.

It is to be understood that although the terms first, second, third, etc. may be employed in the examples of the disclosure to describe various information, such information should not be limited to these terms. These terms are merely used to distinguish the same type of information from each other. For example, first information may also be referred to as second information, and similarly, second information may also be referred to as first information, without departing from the scope of the examples of the disclosure. The word “if” as used herein may be construed to mean “upon” or “when” or “in response to determining”, depending on the context.

The present application relates to, but is not limited to, the technical field of radio communication, and in particular relates to a beam determination method and apparatus, and a communication device.

As for a multi-beam based community, considering that the antenna elements mainly operate in a time-division duplex (TDD) mode at the high frequency band, uplink and downlink channels have certain correspondence, so the concept of beam correspondence (BC) is introduced in 5G NR to speed up beam selection. Specifically, if a terminal has the capability of beam correspondence, the terminal can directly take an optimal downlink reception beam as an optimal uplink sending beam; or conversely, an optimal uplink sending beam is taken as an optimal downlink reception beam.

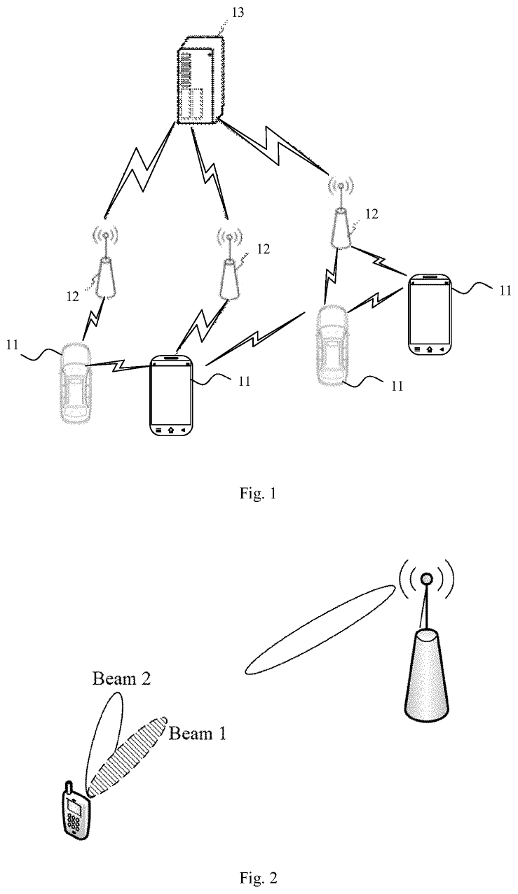

With reference to FIG. 1, a structural schematic diagram of a radio communication system provided in an example of the disclosure is shown. As shown in FIG. 1, the radio communication system is a communication system based on a cellular mobile communication technology. The radio communication system may include: several terminals 11 and several base stations 12.

The terminals 11 may be devices that provide speech and/or data connectivity for a user. Each of the terminals 11 may communicate with one or more core networks by means of a radio access network (RAN), and the terminal 11 may be an Internet of Things terminal, for example, a sensor device, a mobile telephone (or referred to as a “cellular” telephone), and a computer having an Internet of Things terminal, for example, may be a stationary, portable, pocket-sized, hand-held, computer-built, or vehicle-mounted device, for example, a station (STA), a subscriber unit, a subscriber station, a mobile station, a mobile, a remote station, an access point, a remote terminal, an access terminal, a user terminal, a user agent, a user device, or user equipment (UE). Alternatively, each of the terminals 11 may be a device of an unmanned aerial vehicle. Alternatively, each of the terminals 11 may be an in-vehicle device, for example, a trip computer with a radio communication function, or a radio communication device to which a trip computer is externally connected. Alternatively, each of the terminals 11 may be a roadside device, for example, a street lamp, a signal lamp, another roadside device, etc. with the radio communication function.

Each of the base stations 12 may be a network-side device in the radio communication system. The radio communication system may be the 4th generation mobile communication (4G) system, also referred to as a long term evolution (LTE) system; and alternatively, the radio communication system may also be a 5G system, also referred to as a new radio (NR) system or a 5G NR system. Alternatively, the radio communication system may also be a next generation system consecutive to the 5G system. An access network in the 5G system may be referred to as a next generation-radio access network (NG-RAN). Alternatively, the radio communication system may be a machine-type communication (MTC) system.

Each of the base stations 12 may be an evolved Node B (eNB) used in a 4G system. Alternatively, each of the base stations 12 may also be a next-generation Node B (gNB) using a central distributed architecture in a 5G system. When each of the base station 12 uses the central distributed architecture, it typically includes a centralized unit (CU) and at least two distributed units (DU). The central unit is provided with protocol stacks of a packet data convergence protocol (PDCP) layer, a radio link control (RLC) layer and a media access control (MAC) layer; and each distributed unit is provided with a protocol stack of a physical (PHY) layer. Examples of the disclosure are not limited to the specific implementation modes of the base station 12.

A radio connection may be established between the base stations 12 and the terminals 11 by means of radio air interfaces. In different implementation modes, the radio air interface is a radio air interface based on a 4th generation mobile communication network technology (4G) standard; alternatively, the radio air interface is a radio air interface based on a 5th generation mobile communication network technology (5G) standard, for example, the radio air interface is a new radio; and alternatively, the radio air interface may also be a radio air interface based on a 5G-based next generation mobile communication network technology standard.

In some examples, an end to end (E2E) connection may also be established between the terminals 11, for example, vehicle to vehicle (V2V) communication, vehicle to infrastructure (V2I) communication, vehicle to pedestrian (V2P) communication, and other scenes in vehicle to everything (V2X).

In some examples, the above radio communication system may further include a network management device 13.

The several base stations 12 are respectively connected to the network management device 13. The network management device 13 may be a core network device in the radio communication system, for example, the network management device 13 may be a mobility management entity (MME) in an evolved packet core (EPC). Alternatively, the network management device may be another core network device, for example, a serving gateway (SGW), a public data network gateway (PGW), a policy and charging rules function (PCRF), a home subscriber server (HSS), etc. The examples of the disclosure are not limited with respect to an implementation form of the network management device 13.

An execution body related to the examples of the disclosure includes, but is not limited to, a terminal, a base station, etc. performing communication by using a cellular mobile communication technology.

In one application scenario of examples of the disclosure, it is difficult for an uplink beam and a downlink beam to guarantee complete correspondence due to complexity and limitations of terminal design. In practical application, the beam selected by the terminal through beam correspondence tends not to be the optimal beam, and in some cases the beam may be even worse. As shown in FIG. 2, beam 1 is a beam in an optimal direction, and the terminal selects beam 2 through beam correspondence. In this way, not only is the quality of the communication not guaranteed, but also unnecessary power consumption of the terminal is caused.

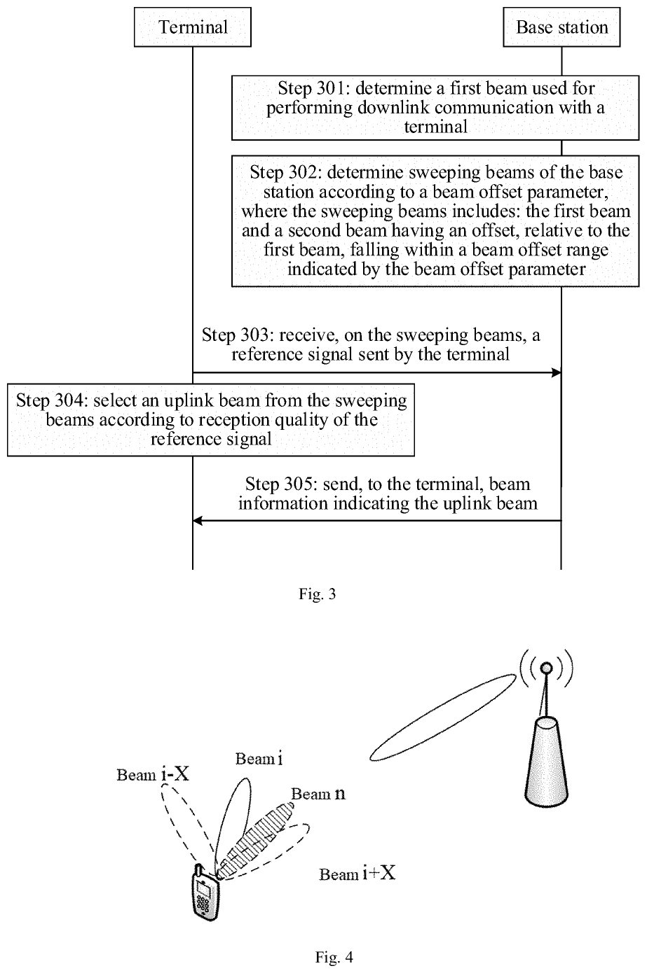

As shown in FIG. 3, the example provides a beam determination method, the method is performed by a base station of radio communication. The beam determination method includes:

step 301: determine a first beam used for performing downlink communication with a terminal;

step 302: determine sweeping beams of the base station according to a beam offset parameter, where the sweeping beams include: the first beam and a second beam having an offset, relative to the first beam, falling within a beam offset range indicated by the beam offset parameter;

step 303: receive, on the sweeping beams, a reference signal sent by the terminal;

step 304: select an uplink beam from the sweeping beams according to reception quality of the reference signal; and

step 305: send, to the terminal, beam information indicating the uplink beam.

Herein, the radio communication may be a cellular mobile communication technology in a time-division duplex (TDD) mode or a cellular mobile communication technology in a frequency-division duplex (FDD) mode.

The terminal may be a terminal supporting a beam correspondence (BC) technique or not. The terminal may be a terminal using beam forming to generate beams for communication. The base station may be a base station using beam forming to generate beams for communication.

The first beam may be a downlink beam of a current communication between the base station and the terminal, or a beam preset by the base station and the terminal; or the first beam is a beam with optimal signal quality, reported by the terminal based on the reference signal sent by the downlink beam of the base station. The terminal may use beam correspondence to send uplink information on the first beam by means of the beam correspondence technique. The first beam may be a downlink beam, with the optimal signal quality, selected by the terminal, and the terminal may notify the base station by means of uplink information, etc. after determining the downlink beam with the optimal signal quality, and in this way, the base station may determine the first beam.

The sweeping beam may be an alternative uplink beam selected by the terminal or the base station and used for uplink data. The second beam may be determined based on the first beam according to the beam offset parameter. The beam offset parameter may be negotiated by a communication protocol or may be indicated by the terminal to the base station in an uplink information mode. There may be one or more sweeping beams.

The sweeping beams may include a first beam and a second beam. The sweeping beam may be one or more beams generated by beam forming during communication between the terminal and the base station. The sweeping beams include different beams having different beam directions. The beam offset parameter is used to indicate a beam offset range of the second beam relative to the first beam, for example, a maximum beam offset angle or number of an offset beam, etc.

The terminal may send the reference signal to the base station on the first beam and the second beam, that is, the sweeping beams, by means of each sweeping beam respectively.

The base station determines, according to the determined first beam and the beam offset parameter, a second beam needing to receive the reference signal. The reference signal is received on the first beam and the second beam, that is, on the sweeping beams.

Illustratively, the beam offset range indicated by the beam offset parameter may be a maximum beam offset angle, with the maximum beam offset angle being 60 degrees as an example. The first beam and all second beams in 60 degrees on two sides of the first beam are sweeping beams.

The base station may determine an uplink beam for subsequent data uplink transmission of the terminal according to the signal quality of the received reference signal, etc.

Illustratively, the base station may compare bit error rates of the reference signals of the sweeping beams, and then may use a sweeping beam with a minimum bit error rate as the uplink beam.

After the base station determines the uplink beam, beam indication information indicating the uplink beam may be sent. The terminal determines an uplink beam according to the indication of the beam indication information, and may perform data uplink transmission by using the determined uplink beam. The beam indication information may indicate an uplink beam by using a beam identifier, etc.

In this way, the base station may determine an uplink beam with optimal uplink quality based on a received condition of the reference signal of each sweeping beam. Accordingly, on the one hand, the uncertainty of selecting the uplink beam due to limitation of the terminal itself may be reduced by this solution. On the other hand, due to the non-correspondence of the channel, the phenomenon that the base station uses an uplink beam with the optimal quality determined by the terminal to perform uplink transmission, resulting in poor signal quality is reduced. In other words, by using the technical solution provided in the examples of the present application, the transmission quality may be improved, so as to reduce extra power consumption caused by poor transmission quality, retransmission, etc. of the terminal.

In one example, the beam offset parameter includes a maximum number offset.

The second beam is a beam having an offset, between a beam number of the second beam and a beam number of the first beam, less than or equal to the maximum number offset.

Herein, the beams formed by means of beam forming by the terminal all have corresponding numbers, and the maximum number offset is the maximum number of second beams adjacent to the first beam and consecutive in number on either side of the first beam. In this way, the sweeping beams may be the first beam and beams within a maximum number offset range on two sides of the first beam.

As shown in FIG. 4, beam i is the first beam, and the maximum number offset is X, that is, the terminal and the base station may use beam i and a beam with a beam number offset within X on two sides of beam i as the sweeping beams. X may be 0 or a positive integer of 1, 2, 3, etc. As an example of X=2, the beam numbers of beam i−2, beam i−1, beam i+1, and beam i+2 fall within X relative to the beam offset of beam i, such that, the four beams of beam i−2, beam i−1, beam i+1, and beam i+2 may be determined as the second beams.

The terminal determines beam i and the second beam with the beam number offset within X relative to beam i as sweeping beams, and send the reference signal by using each sweeping beam.

The base station receives a reference signal by means of beam i and the second beam with the beam number offset within X relative to beam i, and may determine beam n with the optimal signal quality from beam i and the second beam with the beam number offset within X relative to beam i as an uplink beam according to the received signal quality, etc. of the reference signal.

In one example, the beam offset parameter includes a maximum offset angle.

The second beam is a beam having an offset angle, between a reception angle of the second beam and a transmitting angle of the first beam, less than or equal to the maximum offset angle.

The base station or the terminal generates beams at a preset interval angle during beam forming. The maximum offset angle may be a maximum value of included angles between the first beam and the second beams located on one side of the first beam. Herein, the beam included angle may be an included angle of a center line of the beam.

After the maximum value of the offset angle is determine, all beams within the maximum value of the offset angle may be determined.

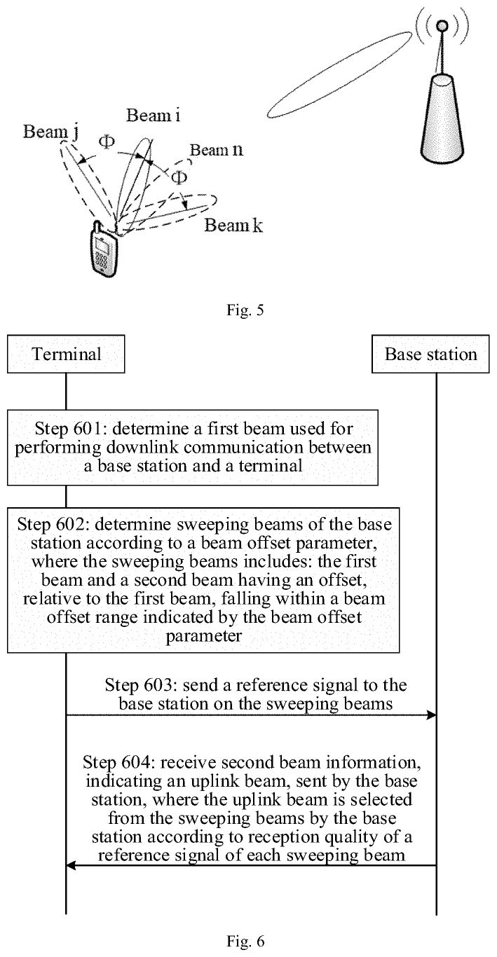

As shown in FIG. 5, beam i is the first beam, and the maximum value of the offset angle is Φ, that is, the terminal and the base station may use beam i and second beams, on two sides of beam i, with included angles between beam i and the second beams within Φ as sweeping beams. That is, beam i, all second beams between beam i and beam j, and all second beams between beam i and beam k are determined as sweeping beams, and a reference signal is sent by using each sweeping beam.

The base station receives the reference signal on the sweeping beam, and may determine beam n with optimal signal quality from beam i, all second beams between beam i and beam j, and all second beams between beam i and beam k as an uplink beam according to received signal quality of the reference signal, etc.

In one example, the beam determination method may further include: receive the beam offset parameter reported by the terminal.

The terminal may determine a beam offset parameter according to its own capability of beam generation by means of beam forming, and send the beam offset parameter to the base station. The beam offset parameter may also be preset.

Illustratively, the beam offset parameter may be sent by using the first beam according to techniques, for example, beam correspondence.

In one example, the step of determining a first beam used for performing downlink communication with a terminal includes: determine a beam sending a beam offset parameter as the first beam.

The terminal may select one downlink beam from a plurality of alternative downlink beams by means of beam correspondence to send the beam offset parameter, and uses the downlink beam as a reference beam of the sweeping beams, that is, the first beam. The base station may use the beam used by the terminal to send the beam offset parameter as the first beam. Therefore, the base station and the terminal select one beam as the first beam and use one beam offset parameter, so as to achieve uniformity of the sweeping beams. The situation that omission of the reference signal received by the base station occurs due to non-uniform sweeping beams when the terminal sends the reference signal is reduced.

In one example, the beam determination method may further include: obtain a pre-negotiated or protocol-specified beam offset parameter.

Herein, the beam offset parameter may be pre-negotiated by the base station or the terminal or specified by a communication protocol. If the beam parameter is not determined in a default mode, for example, pre-negotiation or writing in a communication standard, the base station also receives the beam offset parameter from the terminal.

As shown in FIG. 4, beam i is the first beam, and the maximum number offset is X. X may be pre-negotiated to be 2.

In this way, the terminal needs no uplink beam offset parameter, and the base station and the terminal may determine the identical second beam according to the first beam. Overheads of the system due to the uplink beam offset parameter may be reduced.

In one example, step 304 may include: determine a sweeping beam with a strongest reference signal as the uplink beam.

Herein, the base station may use the sweeping beam with the strongest reference signal as the uplink beam and indicate the uplink beam to a user terminal by means of beam indication information. The beam indication information may indicate the uplink beam in a mode of carrying a beam identifier of the uplink beam.

The terminal determines, by receiving the beam indication information, the uplink beam indicated by the base station, and performs uplink data transmission by using the uplink beam.

In one example, the first beam is an alternative downlink beam, with a strongest channel state information reference signal (CSI-RS) or a strongest synchronization signal block (SSB) signal, determined by the terminal from one or more alternative downlink beams.

Herein, the first beam may be determined by the terminal from a plurality of alternative downlink beams.

During initial access, the terminal may scan the SSB of a plurality of alternative downlink beams generated by each base station by means of beam forming, determine an optimal alternative downlink beam received for downlink as the first beam, and receive base station downlink information by means of the first beam. Herein, a method for determining an optimal alternative downlink beam received for downlink may include: measure signal receiving power of SSB of each alternative downlink beam, and determine an alternative downlink beam with strongest signal receiving power of the SSB as the current downlink beam.

During initial access, the terminal may scan the CSI-RS of a plurality of alternative downlink beams generated by each base station by means of beam forming, determine an optimal alternative downlink beam received for downlink as the first beam, and receive base station downlink information by means of the first beam. Herein, a method for determining an optimal alternative downlink beam received for downlink may include: measure signal receiving power of CSI-RS of each alternative downlink beam, and determine an alternative downlink beam with strongest signal receiving power of the CSI-RS as the current downlink beam.

As shown in FIG. 6, the example provides a beam determination method, the method is performed by a terminal of radio communication. The beam determination method includes:

step 601: determine a first beam used for performing downlink communication between a base station and a terminal;

step 602: determine sweeping beams of the base station according to a beam offset parameter, where the sweeping beams include: the first beam and a second beam having an offset, relative to the first beam, falling within a beam offset range indicated by the beam offset parameter;

step 603: send a reference signal to the base station on the sweeping beams; and

step 604: receive second beam information, indicating an uplink beam, sent by the base station, where the uplink beam is selected from the sweeping beams by the base station according to reception quality of a reference signal of each sweeping beam.

Herein, the radio communication may be a cellular mobile communication technology in a time-division duplex (TDD) mode or a cellular mobile communication technology in a frequency-division duplex (FDD) mode.

The terminal may be a terminal supporting a beam correspondence (BC) technique or not. The terminal may be a terminal using beam forming to generate beams for communication. The base station may be a base station using beam forming to generate beams for communication.

The first beam may be a downlink beam of current communication between the base station and the terminal, or a beam preset by the base station and the terminal; or the first beam is a beam, with optimal signal quality, reported by the terminal based on the reference signal sent by the downlink beam of the base station. The terminal may use beam correspondence to send uplink information on the first beam by means of the beam correspondence technique. The first beam may be a downlink beam, with the optimal signal quality, selected by the terminal, and the terminal may notify the base station by means of uplink information, etc. after determining the downlink beam with the optimal signal quality, and in this way, the base station may determine the first beam.

The sweeping beam may be an alternative uplink beam selected by the terminal or the base station and used for uplink data. The second beam may be determined based on the first beam according to the beam offset parameter. The beam offset parameter may be negotiated by a communication protocol or may be indicated by the terminal to the base station in an uplink information mode. There may be one or more sweeping beams.

The sweeping beams may include a first beam and a second beam. The sweeping beam may be one or more beams generated by beam forming during communication between the terminal and the base station. The sweeping beams include different beams having different beam directions. The beam offset parameter is used to indicate a beam offset range of the second beam relative to the first beam, for example, a maximum beam offset angle, or number of an offset beam, etc.

The terminal may send the reference signal to the base station on the first beam and the second beam, that is, the sweeping beams, by means of each sweeping beam respectively.

The base station determines, according to the determined first beam and the beam offset parameter, a second beam needing to receive the reference signal. The reference signal is received on the first beam and the second beam, that is, on the sweeping beams.

Illustratively, the beam offset range indicated by the beam offset parameter may be a maximum beam offset angle, with the maximum beam offset angle being 60 degrees as an example. The first beam and all second beams in 60 degrees on two sides of the first beam are sweeping beams.

The base station may determine an uplink beam for subsequent data uplink transmission of the terminal according to the signal quality of the received reference signal, etc.

Illustratively, the base station may compare bit error rates of the reference signals of the sweeping beams, and then may use a sweeping beam with a minimum bit error rate as the uplink beam.

After the base station determines the uplink beam, beam indication information indicating the uplink beam may be sent. The terminal determines an uplink beam according to the indication of the beam indication information, and may perform data uplink transmission by using the determined uplink beam. The beam indication information may indicate an uplink beam by using a beam identifier, etc.

In this way, the base station may determine an uplink beam with optimal uplink quality based on a received condition of the reference signal of each sweeping beam. On the one hand, the uncertainty of selecting the uplink beam due to limitation of the terminal itself may be reduced by this solution. On the other hand, due to the non-correspondence of the channel, the phenomenon that the base station uses an uplink beam with the optimal quality determined by the terminal to perform uplink transmission, resulting in poor signal quality is reduced. In other words, by using the technical solution provided in the examples of the present application, the transmission quality may be improved, so as to reduce extra power consumption caused by poor transmission quality, retransmission, etc. of the terminal.

In one example, the beam offset parameter includes a maximum number offset.

The second beam is a beam having an offset, between a beam number of the second beam and a beam number of the first beam, less than or equal to the maximum number offset.

Herein, the beams formed by means of beam forming by the terminal all have corresponding numbers, and the maximum number offset is the maximum number of second beams adjacent to the first beam and consecutive in number on either side of the first beam. In this way, the sweeping beams may be the first beam and beams within a maximum number offset range on two sides of the first beam.

As shown in FIG. 4, beam i is the first beam, and the maximum number offset is X, that is, the terminal and the base station may use beam i and a beam with a beam number offset within X on two sides of beam i as the sweeping beams. X may be 0 or a positive integer of 1, 2, 3, etc. As an example of X=2, the beam numbers of beam i−2, beam i−1, beam i+1, and beam i+2 fall within X relative to the beam offset of beam i, such that, the four beams of beam i−2, beam i−1, beam i+1, and beam i+2 may be determined as the second beams.

The terminal determines beam i and X second beam on each of two sides of beam i as sweeping beams, and send the reference signal by using each sweeping beam.

The base station receives a reference signal by means of beam i and the second beam with the beam number offset within X relative to beam i, and may determine beam n with the optimal signal quality from beam i and the second beam with the beam number offset within X relative to beam i as an uplink beam according to the received signal quality, etc. of the reference signal.

In one example, the beam offset parameter includes a maximum offset angle.

The second beam is a beam having an offset angle, between a reception angle of the second beam and a transmitting angle of the first beam, less than or equal to the maximum offset angle.

The base station or the terminal generates beams at a preset interval angle during beam forming. The maximum offset angle may be a maximum value of included angles between the first beam and the second beams located on one side of the first beam. Herein, the beam included angle may be an included angle of a center line of the beam.

After the maximum value of the offset angle is determine, all beams within the maximum value of the offset angle may be determined.

As shown in FIG. 5, beam i is the first beam, and the maximum value of the offset angle is Φ, that is, the terminal and the base station may use beam i and second beams, on two sides of beam i, with included angles between beam i and the second beams within Φ as sweeping beams. That is, beam i, all second beams between beam i and beam j, and all second beams between beam i and beam k are determined as sweeping beams, and a reference signal are sent by using each sweeping beam.

The base station receives the reference signal on the sweeping beam, and may determine beam n with optimal signal quality from beam i, all second beams between beam i and beam j, and all second beams between beam i and beam k as an uplink beam according to received signal quality of the reference signal, etc.

In one example, the beam determination method may further include:

report the beam offset parameter on the first beam.

The terminal may determine a beam offset parameter according to its own capability of beam generation by means of beam forming, and send the beam offset parameter to the base station. The beam offset parameter may also be preset.

Illustratively, the beam offset parameter may be sent by using the first beam according to techniques, for example, beam correspondence.

The terminal may select one downlink beam from a plurality of alternative downlink beams by means of beam correspondence to send the beam offset parameter, and uses the downlink beam as a reference beam of the sweeping beams, that is, the first beam. The base station may use the beam used by the terminal to send the beam offset parameter as the first beam. Therefore, the base station and the terminal select one beam as the first beam and use one beam offset parameter, so as to achieve uniformity of the sweeping beams. The situation that omission of the reference signal received by the base station occurs due to non-uniform sweeping beams when the terminal sends the reference signal is reduced.

In one example, the beam determination method may further include:

obtain a pre-negotiated or protocol-specified beam offset parameter.

Herein, the beam offset parameter may be pre-negotiated by the base station or the terminal or specified by a communication protocol. If the beam parameter is not determined in a default mode, for example, pre-negotiation or a writing in a communication standard, the base station also receives the beam offset parameter from the terminal.

As shown in FIG. 4, beam i is the first beam, and the maximum number offset is X. X may be pre-negotiated to be 2.

In this way, the terminal needs no uplink beam offset parameter, and the base station and the terminal may determine the identical second beam according to the first beam. Overheads of the system due to the uplink beam offset parameter may be reduced by this solution.

In one example, the uplink beam includes a sweeping beam with a strongest reference signal determined by the base station.

Herein, the base station may use the sweeping beam with the strongest reference signal as the uplink beam and indicate the uplink beam to a user terminal by means of beam indication information. The beam indication information may indicate the uplink beam in a mode of carrying a beam identifier of the uplink beam.

The terminal determines, by receiving the beam indication information, the uplink beam indicated by the base station, and performs uplink data transmission by using the uplink beam.

In one example, step 601 may include:

determine an alternative downlink beam with a strongest CSI-RS in one or more alternative downlink beams as the first beam; or

determine an alternative downlink beam with a strongest SSB signal in one or more alternative downlink beams as the first beam.

Herein, the first beam may be determined by the terminal from a plurality of alternative downlink beams.

During initial access, the terminal may scan the SSB of a plurality of alternative downlink beams generated by each base station by means of beam forming, determine an optimal alternative downlink beam received for downlink as the first beam, and receive base station downlink information by means of the first beam. Herein, a method for determining an optimal alternative downlink beam received for downlink may include: measure signal receiving power of SSB of each alternative downlink beam, and determine an alternative downlink beam with strongest signal receiving power of the SSB as the current downlink beam.

During initial access, the terminal may scan the CSI-RS of a plurality of alternative downlink beams generated by each base station by means of beam forming, determine an optimal alternative downlink beam received for downlink as the first beam, and receive base station downlink information by means of the first beam. Herein, a method for determining an optimal alternative downlink beam received for downlink may include: measure signal receiving power of CSI-RS of each alternative downlink beam, and determine an alternative downlink beam with strongest signal receiving power of the CSI-RS as the current downlink beam.

A specific instance is provided below in conjunction with any one of the examples described above:

The beam determination method provided in this specific instance includes the specific steps as follows:

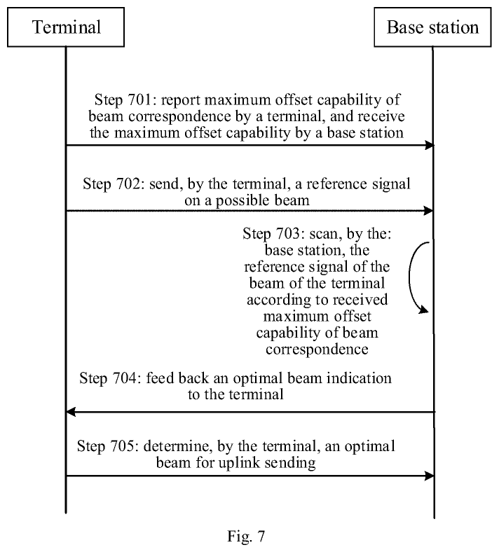

1. As shown in FIG. 7, steps at a terminal side include:

step 701, report, by a terminal, maximum offset capability of beam correspondence to a base station, where the maximum offset capability may be the maximum number of beam offset that the terminal may support;

step 702: send, by the terminal, a reference signal (RS) on a beam that may be supported; and

step 705: determine, by the terminal, an optimal beam for sending according to feedback of the base station.

2. As shown in FIG. 7, steps at a base station side include:

step 701: receive, by a base station, maximum offset capability of beam correspondence reported by a terminal, for example, the maximum number of beam offset that the terminal may support;

step 703: scan, by the base station, a reference signal of a beam of the terminal according to received maximum offset capability of beam correspondence, and determine an indication of an optimal beam; and

step 704: feed back, by the base station, the indication of the optimal beam to the terminal.

Instance 1:

As shown in FIG. 4, a terminal scans a synchronization signal block (SSB) during initial access, to determine optimal beam i received for downlink. Herein, a method for determining a strongest beam is the same as a conventional method to measure receiving power of a SSB signal of each beam. The terminal reports the maximum offset capability of beam correspondence to the base station. In a preferred example, the maximum offset capability is the maximum possible number of beam offset X, X=1, 2, 3 and other integers, and if the terminal does not report the capability, the capability may also be set as a default value, for example, X=2 by default. The terminal sends a reference signal at possible uplink beams, the possible uplink beams are from beam i−X to beam i+X, and the base station scans the reference signal of the beam of the terminal within a range from beam i−X to beam i+X according to the received maximum offset capability of beam correspondence, determines the indication of the optimal beam, and feeds back the indication to the terminal.

Instance 2:

As shown in FIG. 4, a terminal scans a channel state information reference signal (CSI-RS) sent by a base station, and determines optimal beam i received for downlink according to signal power, for example, maximum reference signal receiving power (RSRP), and the terminal reports the maximum offset capability of beam correspondence to the base station. In a preferred example, the maximum offset capability is the maximum possible number of beam offset X, and X=1, 2, 3 and other integers. If the terminal does not report the capability, the capability may also be set as a default value, for example, X=2 by default. The terminal sends a reference signal on possible uplink beams, and the possible uplink beams are from beam i−X to beam i+X.

The base station scans the reference signal of the beam of the terminal within a range from beam i−X to beam i+X according to the received maximum offset capability of beam correspondence, determines the indication of the optimal beam, and feeds back the indication to the terminal.

Instance 3:

As shown in FIG. 5, a terminal scans a SSB or CSI-RS signal sent by a base station to determine optimal beam i received for downlink, and the terminal reports the maximum offset capability of beam correspondence to the base station. In another example, the maximum offset capability is a maximum possible beam offset angle Φ, the terminal sends a reference signal at possible beams, and the possible beams include all possible beams with offset angles less than the offset angle.

The base station scans the reference signal of the beam of the terminal within a range the maximum offset angle Φ different from beam i according to the received maximum offset capability of beam correspondence, determines the indication of the optimal beam, and feeds back the indication to the terminal.

Instance 4:

In another example, when the terminal has no beam correspondence capability, the method is still applicable.

The method not only may be used for a TDD system, but also may be used for an FDD system.

As shown in FIG. 3, the beam determination method provided in this instance includes the following.

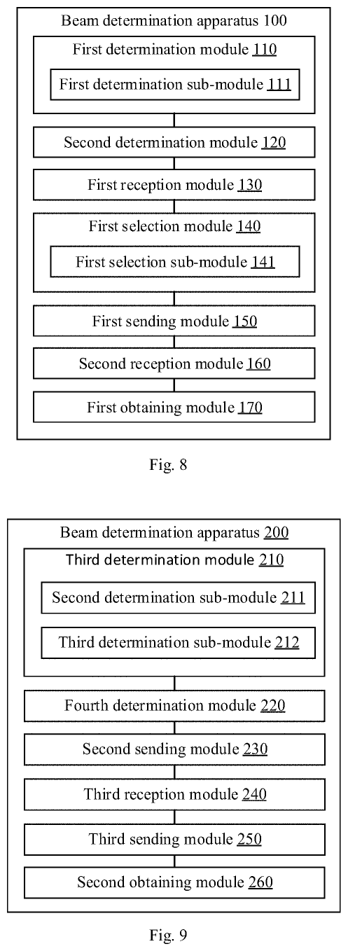

The examples of the disclosure further provide a beam determination apparatus, used for a base station of radio communication. FIG. 8 is a structural schematic diagram of composition of the beam determination apparatus 100 provided in an example of the disclosure. As shown in FIG. 8, the apparatus 100 includes: a first determination module 110, a second determination module 120, a first reception module 130, a first selection module 140 and a first sending module 150, where

the first determination module 110 is configured to determine a first beam used for performing downlink communication with a terminal;

the second determination module 120 is configured to determine sweeping beams of a base station according to a beam offset parameter, where the sweeping beams include: the first beam and a second beam having an offset, relative to the first beam, falling within a beam offset range indicated by the beam offset parameter;

the first reception module 130 is configured to receive, on the sweeping beams, a reference signal sent by the terminal;

the first selection module 140 is configured to select an uplink beam from the sweeping beams according to reception quality of the reference signal; and

the first sending module 150 is configured to send, to the base station, beam information indicating the uplink beam.

In one example, the beam offset parameter includes a maximum number offset.

The second beam is a beam having an offset, between a beam number of the second beam and a beam number of the first beam, less than or equal to the maximum number offset.

In one example, the beam offset parameter includes a maximum offset angle.

The second beam is a beam having an offset angle, between a reception angle of the second beam and a transmitting angle of the first beam, less than or equal to the maximum offset angle.

In one example, the apparatus 100 further includes:

a second reception module 160 configured to receive the beam offset parameter reported by the terminal.

The first determination module 110 includes:

a first determination sub-module 111 configured to determine a beam sending the beam offset parameter as the first beam.

In one example, the apparatus 100 further includes:

a first obtaining module 170 configured to obtain a pre-negotiated or protocol-specified beam offset parameter.

In one example, the first selection module 140 includes:

a first selection sub-module 141 configured to determine a sweeping beam with a strongest reference signal as the uplink beam.

In one example, the first beam is an alternative downlink beam, with a strongest CSI-RS or a strongest SSB signal, determined by the terminal from one or more alternative downlink beams.

The examples of the disclosure further provide a beam determination apparatus, used for a terminal of radio communication. FIG. 9 is a structural schematic diagram of composition of the beam determination apparatus 200 provided in an example of the disclosure. As shown in FIG. 9, the apparatus 200 includes: a third determination module 210, a fourth determination module 220, a second sending module 230, and a third reception module 240, where

the third determination module 210 is configured to determine a first beam used for performing downlink communication between a base station and the terminal;

the fourth determination module 220 is configured to determine sweeping beams of a base station according to a beam offset parameter, where the sweeping beams include: the first beam and a second beam having an offset, relative to the first beam, falling within a beam offset range indicated by the beam offset parameter;

the second sending module 230 is configured to send a reference signal to the base station on the sweeping beams; and

the third reception module 240 is configured to receive second beam information, indicating an uplink beam, sent by the base station, where the uplink beam is selected from the sweeping beams by the base station according to reception quality of a reference signal of each sweeping beam.

In one example, the beam offset parameter includes a maximum number offset.

The second beam is a beam having an offset, between a beam number of the second beam and a beam number of the first beam, less than or equal to the maximum number offset.

In one example, the beam offset parameter includes a maximum offset angle.

The second beam is a beam having an offset angle, between a reception angle of the second beam and a transmitting angle of the first beam, less than or equal to the maximum offset angle.

In one example, the apparatus 200 further includes:

a third sending module 250 configured to report the beam offset parameter on the first beam.

In one example, the apparatus 200 further includes:

a second obtaining module 260 configured to obtain a pre-negotiated or protocol-specified beam offset parameter.

In one example, the uplink beam includes a sweeping beam with a strongest reference signal determined by the base station.

In one example, the third determination module 210 includes one of the following:

a second determination sub-module 211 configured to determine an alternative downlink beam with a strongest CSI-RS in one or more alternative downlink beams as the first beam; or

a third determination sub-module 212 configured to determine an alternative downlink beam with a strongest SSB signal in one or more alternative downlink beams as the first beam.

In an example, a first determination module 110, a second determination module 120, a first reception module 130, a first selection module 140, a first sending module 150, a second reception module 160, a first obtaining module 170, a third determination module 210, a fourth determination module 220, a second sending module 230, a third reception module 240, a third sending module 250, and a second obtaining module 260, etc. may be implemented by one or more of a central processing unit (CPU), a graphics processing unit (GPU), a baseband processor (BP), an application specific integrated circuit (ASIC), a digital signal processor (DSP), a programmable logic device (PLD), a complex programmable logic device (CPLD), a field-programmable gate array (FPGA), a general-purpose processor, a controller, a micro controller unit (MCU), a microprocessor, or other electronic components, so as to execute the method.

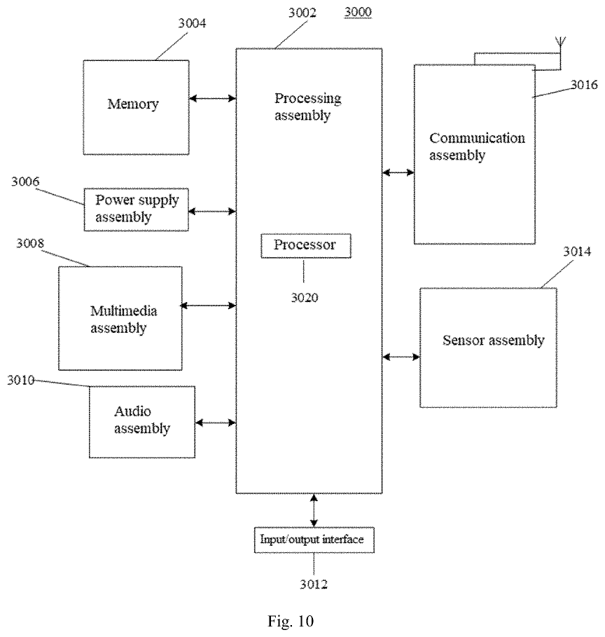

FIG. 10 is a block diagram of a beam determination apparatus 3000 according to an example. For example, the apparatus 3000 may be a mobile phone, a computer, a digital broadcast terminal, a messaging device, a gaining console, a tablet device, a medical device, a fitness device, a personal digital assistant, etc.

With reference to FIG. 10, the apparatus 3000 may include one or more of a processing assembly 3002, a memory 3004, a power supply assembly 3006, a multimedia assembly 3008, an audio assembly 3010, an input/output (I/O) interface 3012, a sensor assembly 3014, and a communication assembly 3016.

The processing assembly 3002 generally controls overall operation of the apparatus 3000, for example, operations associated with display, phone calls, beam determination, camera operations, and recording operations. The processing assembly 3002 may include one or more processors 3020 to execute an instruction to complete all or part of the steps of the method above. Moreover, the processing assembly 3002 may include one or more modules to facilitate interaction between the processing assembly 3002 and other assemblies. For example, the processing assembly 3002 may include the multimedia module to facilitate interaction between the multimedia assembly 3008 and the processing assembly 3002.

The memory 3004 is configured to store various types of data to support operation on the apparatus 3000. Examples of such data include an instruction, operated on the apparatus 3000, for any application or method, contact data, phonebook data, messages, pictures, video, etc. The memory 3004 may be implemented by any type of volatile or non-volatile memory apparatus, or a combination thereof, for example, a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The power supply assembly 3006 provides power for the various assemblies of the apparatus 3000. The power supply assembly 3006 may include a power management system, one or more power supplies, and other assemblies associated with power generating, managing, and distributing for the apparatus 3000.

The multimedia assembly 3008 includes a screen that provides an output interface between the apparatus 3000 and the user. In some examples, the screen may include a liquid crystal display (LCD) and a touch panel (TP). Under the condition that the screen includes the touch panel, the screen may be implemented as a touch screen to receive an input signal from the user. The touch panel includes one or more touch sensors to sense touches, slides, and gestures on the touch panel. The touch sensor may not only sense a boundary of a touch or swipe action, but also detect duration and pressure related to the touch or swipe operation. In some examples, the multimedia assembly 3008 includes a front-facing camera and/or a rear-facing camera. When the apparatus 3000 is in an operational mode, for instance, a photographing mode or a video mode, the front-facing camera and/or the rear-facing camera may receive external multimedia data. Each of the front-facing camera and the rear-facing camera may be a fixed optical lens system or have a focal length and optical zoom capability.

The audio assembly 3010 is configured to output and/or input an audio signal. For example, the audio assembly 3010 includes a microphone (MIC) configured to receive an external audio signal when the apparatus 3000 is in the operational mode, for example, a calling mode, a recording mode, and a speech recognition mode. The received audio signal may be further stored in the memory 3004 or sent via the communication assembly 3016. In some examples, the audio assembly 3010 further includes a speaker for outputting the audio signal.

The I/O interface 3012 provides an interface between the processing assembly 3002 and a peripheral interface module, which may be a keyboard, a click wheel, a button, etc. These buttons may include but are not limited to a home button, a volume button, a start button, and a lock button.

The sensor assembly 3014 includes one or more sensors for providing state assessments of various aspects for the apparatus 3000. For example, the sensor assembly 3014 may detect an on/off state of the apparatus 3000 and relative positioning of the assemblies. For example, the assemblies are a display and a keypad of the apparatus 3000. The sensor assembly 3014 may also detect a change in position of the apparatus 3000 or an assembly of the apparatus 3000, the presence or absence of contact between the user and the apparatus 3000, orientation or acceleration/deceleration of the apparatus 3000, and temperature variation of the apparatus 3000. The sensor assembly 3014 may include a proximity sensor configured to detect presence of nearby objects in the absence of any physical contact. The sensor assembly 3014 may also include a light sensor, for instance, a complementary metal oxide semiconductor (CMOS) or charge coupled device (CCD) image sensor, for use in imaging applications. In some examples, the sensor assembly 3014 may also include an acceleration sensor, a gyroscopic sensor, a magnetic sensor, a pressure sensor, or a temperature sensor.

The communication assembly 3016 is configured to facilitate communications between the apparatus 3000 and other device in a wired or wireless mode. The apparatus 3000 may access a wireless network based on a communication standard, for example, Wi-Fi, 2G, or 3G, or a combination thereof. In one illustrative example, the communication assembly 3016 receives a broadcast signal or broadcast related information from an external broadcast management system via a broadcast channel In one illustrative example, the communication assembly 3016 also includes a near field communication (NFC) module to facilitate short-range communication. For example, the NFC module may be implemented based on a radio frequency identification (RFID) technology, an infrared data association (IrDA) technology, an ultra wide band (UWB) technology, a Bluetooth® (BT) technology, and other technologies.

In the illustrative example, the apparatus 3000 may be implemented by one or more application specific integrated circuits (ASIC), a digital signal processor (DSP), a digital signal processing device (DSPD), a programmable logic device (PLD), a field programmable gate array (FPGA), a controller, a microcontroller, a microprocessor, or other electronic elements for executing the method above.

In the illustrative example, further provided is a non-transitory computer-readable storage medium including an instruction, for example, a memory 3004 including an instruction, and the instruction may be executed by the processor 3020 of the apparatus 3000 so as to execute the method above. For example, the non-transitory computer-readable storage medium may be a read-only memory (ROM), a random access memory (RAM), a compact disc read-only memory (CD-ROM), a magnetic tape, a floppy disk, an optical data storage apparatus, etc.

Other implementation solutions of the examples of the disclosure will readily occur to those skilled in the art upon consideration of the specification and practical disclosure. The present application is intended to cover any variations, uses, or adaptations of the examples of the disclosure, and these variations, uses, or adaptations follow general principles of the examples of the disclosure and include common general knowledge or customary technical means in the technical field not disclosed in the examples of the disclosure. The specification and examples are considered as illustrative merely, and a true scope and spirit of the examples of the disclosure are indicated by the following claims.

It is to be understood that the examples of the disclosure are not limited to the precise structures that have been described above and shown in the accompanying drawings, and that various modifications and changes may be made without departing from its scope. The scope of the examples of the disclosure is limited only by the appended claims.

1. A beam determination method, the method is performed by a base station, and comprising:
determining a first beam used for performing downlink communication with a terminal;
determining sweeping beams of a base station according to a beam offset parameter, wherein the sweeping beams comprise: the first beam and a second beam having an offset, relative to the first beam, falling within a beam offset range indicated by the beam offset parameter;
receiving, on the sweeping beams, a reference signal sent by the terminal;
selecting an uplink beam from the sweeping beams according to reception quality of the reference signal; and
sending, to the terminal, beam information indicating the uplink beam.

2. The method according to claim 1, wherein the beam offset parameter comprises a maximum number offset; and
the second beam is a beam having an offset, between a beam number of the second beam and a beam number of the first beam, less than or equal to the maximum number offset.

3. The method according to claim 1, wherein the beam offset parameter comprises a maximum offset angle; and
the second beam is a beam having an offset angle, between a reception angle of the second beam and a transmitting angle of the first beam, less than or equal to the maximum offset angle.

4. The method according to claim 1, further comprising:
receiving the beam offset parameter reported by the terminal; wherein
the determining a first beam used for performing downlink communication with a terminal comprises:
determining a beam sending the beam offset parameter as the first beam.

5. The method according to claim 1, further comprising:
obtaining a pre-negotiated or protocol-specified beam offset parameter.

6. The method according to claim 1, wherein the selecting an uplink beam from the sweeping beams according to reception quality of the reference signal comprises:
determining a sweeping beam with a strongest reference signal as the uplink beam.

7. The method according to claim 1, wherein the first beam is an alternative downlink beam, with a strongest channel state information reference signal (CSI-RS) or a strongest synchronization signal block (SSB) signal, determined by the terminal from one or more alternative downlink beams.

8. A beam determination method, the method is performed by a terminal, and comprising:
determining a first beam used for performing downlink communication between a base station and the terminal;
determining sweeping beams of the base station according to a beam offset parameter, wherein the sweeping beams comprise: the first beam and a second beam having an offset, relative to the first beam, falling within a beam offset range indicated by the beam offset parameter;
sending a reference signal to the base station on the sweeping beams; and
receiving second beam information, indicating an uplink beam, sent by the base station, wherein the uplink beam is selected from the sweeping beams by the base station according to reception quality of a reference signal of each sweeping beam.

9. The method according to claim 8, wherein
the beam offset parameter comprises a maximum number offset; and
the second beam is a beam having an offset, between a beam number of the second beam and a beam number of the first beam, less than or equal to the maximum number offset.

10. The method according to claim 8, wherein
the beam offset parameter comprises a maximum offset angle; and
the second beam is a beam having an offset angle, between a reception angle of the second beam and a transmitting angle of the first beam, less than or equal to the maximum offset angle.

11. The method according to claim 8, further comprising:
reporting the beam offset parameter on the first beam.

12. The method according to claim 8, further comprising:
obtaining a pre-negotiated or protocol-specified beam offset parameter.

13. The method according to claim 8, wherein the uplink beam comprises a sweeping beam with a strongest reference signal determined by the base station.

14. The method according to claim 8, wherein the determining a first beam used for performing downlink communication between a base station and the terminal comprises:
determining an alternative downlink beam with a strongest channel state information reference signal (CSI-RS) from one or more alternative downlink beams as the first beam; or
determining an alternative downlink beam with a strongest synchronization signal block (SSB) signal from one or more alternative downlink beams as the first beam.

15.-16. (canceled)

17. A communication device, comprising a processor, a transceiver, a memory, and an executable program stored on the memory and executable by the processor, wherein the processor is configured to:
determine a first beam used for performing downlink communication with a terminal;
determine sweeping beams of a base station according to a beam offset parameter, wherein the sweeping beams comprise: the first beam and a second beam having an offset, relative to the first beam, falling within a beam offset range indicated by the beam offset parameter;
receive, on the sweeping beams, a reference signal sent by the terminal;
select an uplink beam from the sweeping beams according to reception quality of the reference signal; and
send, to the terminal, beam information indicating the uplink beam.

18. A communication device, comprising a processor, a transceiver, a memory, and an executable program stored on the memory and executable by the processor, wherein the processor executes, when running the executable program, steps of the beam determination method according to claim 8.

19. The communication device according to claim 17, wherein the beam offset parameter comprises a maximum number offset, and the second beam is a beam having an offset, between a beam number of the second beam and a beam number of the first beam, less than or equal to the maximum number offset; or,
the beam offset parameter comprises a maximum offset angle, and the second beam is a beam having an offset angle, between a reception angle of the second beam and a transmitting angle of the first beam, less than or equal to the maximum offset angle.

20. The communication device according to claim 17, wherein the processor is further configured to:
receive the beam offset parameter reported by the terminal;
determine a beam sending the beam offset parameter as the first beam.

21. The communication device according to claim 17, wherein the processor is further configured to:
obtain a pre-negotiated or protocol-specified beam offset parameter.

22. The communication device according to claim 17, wherein the processor is further configured to:
determine a sweeping beam with a strongest reference signal as the uplink beam.
